(19) United States
(12) Patent Application Publication
(10) Pub. No.: US 2018/0064513 A1
(43) Pub. Date: Mar. 8, 2018

(54) GINGIVAL RETRACTOR INSTRUMENT

(71) Applicant: King Abdulaziz University, Jeddah (SA)

(72) Inventors: Fahad Ibrahim FATINY, Jeddah (SA); Mohammed A. WAHBI, Jeddah (SA); Helal M. SONBUL, Jeddah (SA); Motaz A. GHULMAN, Jeddah (SA); Thamer A. ALSAIF, Jeddah (SA)

(73) Assignee: King Abdulaziz University, Jeddah (SA)

(21) Appl. No.: 15/255,667

(22) Filed: Sep. 2, 2016

(51) Int. Cl. A61C 9/00; A61C 3/08

(52) U.S. Cl. CPC A61C 9/0033; A61C 3/08

(57) ABSTRACT

An improved dental instrument is provided for facilitated placement of gingival retraction cord into the gingival crevice surrounding a tooth. The instrument includes a curved edge designed to conform to the curvature of a root surface of a tooth at the gingival level. The gingival retraction cord can thus be placed quickly and easily without significant risk of damage to periodontal attachment tissue at the base of the gingival crevice.

### BACKGROUND OF THE INVENTION

### Field of the Invention

This disclosure relates to a dental instrument for use in placing a gingival retraction cord into the gingival crevice surrounding anterior and posterior teeth. More specifically, this disclosure relates to a gingival retractor instrument designed to facilitate placement of the gingival retraction cord and tooth preparation while preventing or minimizing trauma to adjacent gingival tissue.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Denial restorations, such as crowns and bridges, are well-known in the art, where the exposed crown portion of one or more natural teeth is replaced by a prosthesis formed typically from a gold alloy, which may carry an outer shell of porcelain or the like. In accordance with common restorative procedures, the exposed crown portion of the natural tooth is reduced and shaped by drilling to remove damaged portions and to define a suitable prepared base for supporting a prosthetic crown. In this regard, the natural tooth is normally trimmed to a margin disposed slightly below the gum line defined by the surrounding gingival tissue. This margin constitutes a line of separation between cut and uncut portions of the tooth. A moldable and curable impression material, such as a selected vinyl-based elastomer, is then placed over and about the prepared tooth and allowed to cure, resulting in a resilient mold or impression which is intended to replicate the prepared tooth and surrounding structures within the patient's mouth. This impression is then used according to known casting techniques to produce a custom prosthesis adapted to seat securely onto the prepared tooth and to mate comfortably with adjacent teeth. The prosthesis is installed by cementing onto the prepared tooth in an essentially permanent manner.

The marginal fit between the prosthetic crown and the natural tooth is critical in order to obtain prolonged service life without decay of the prepared tooth in the marginal area. In this regard, to achieve the desired accuracy in marginal detail, it is extremely important for the impression material to flow to and at least slightly beyond the margin of the prepared tooth to insure full reproduction of the marginal area. Unfortunately, since the tooth margin is recessed below the surrounding gum line, the gingival tissue normally blocks flow of the impression material to the desired location. Moreover, trimming of the tooth to the recessed margin is usually accompanied by at least some gingival bleeding around the tooth periphery, where the resultant body fluids can also block the desired flow of the impression material.

In the past, these problems have been addressed by the use of a gingival retraction cord for temporarily separating the gingival tissue from the margin of the prepared tooth. More specifically, subsequent to tooth preparation and before making the impression, a flexible gingival retraction cord or string is normally placed by packing into the gingival crevice surrounding the prepared tooth. This gingival retraction cord is thus placed slightly below the gum line and functions as a spacer to separate the gingival tissue from the tooth in the marginal area. In many cases, the gingival retraction cord is pre-impregnated with a chemical agent that assists in retracting the gingival tissue while reducing the tendency of the tissue to contract immediately when the gingival retraction cord is removed. The gingival retraction cord is then removed immediately prior to making the impression, thereby permitting the impression material to contact and reproduce the marginal area of the tooth.

While the use of a gingival retraction cord enhances the quality of the impression, placement of the gingival retraction cord can be a difficult and time consuming procedure. That is, the gingival tissue normally fits closely about the tooth to define a gingival crest at the gum line. From the gingival crest, the tissue descends alongside the tooth to define a shallow gingival crevice or sulcus, typically having a depth on the order of 1.8 to 2.0 millimeters, the base of which includes periodontal attachment tissue secured to the tooth. The gingival retraction cord must be packed into the gingival crevice to separate the tissue lining the crevice from the tooth, but without disturbing or traumatizing the closely underlying periodontal attachment tissue. In the past, this packing procedure has been performed with a dental instrument having a narrow blunted tip with a squared or convex profile by pressing the instrument tip against the gingival retraction cord to push the gingival retraction cord incrementally into the gingival crevice. More recently, an instrument having a rotatable blunted tip has been proposed (U.S. Pat. No. 4,396,375). In either case, the blunted tip is intended to avoid trauma to the gingival tissue. However, the blunted tip does not securely engage the gingival retraction cord and thus tends to slip off the gingival retraction cord to contact and damage gingival tissue, particularly such as the periodontal attachment tissue at the base of the gingival crevice. When this attachment tissue is damaged in this manner, the tissue tends to heal with at least some gum line recession resulting in potential exposure of the marginal area between the prosthetic crown and the natural tooth.

There exists, therefore, a significant need for improvements in dental instruments of the type used for placing the gingival retraction cord into the gingival crevice surrounding a selected tooth without damaging the adjacent gingival tissue substantially. The present disclosure fulfills this need and provides further related advantages.

### SUMMARY OF THE DISCLOSURE

The foregoing description is intended to provide a general introduction and summary of the present disclosure and is not intended to be limiting in its disclosure unless otherwise explicitly stated. The various embodiments, together with further advantages, will be best understood by reference to the following detailed description taken in conjunction with the accompanying drawings.

The first aspect of the disclosure relates to a dental tool, comprising: (i) a first working end member, (ii) a second working end member, and (iii) a handle therebetween, wherein each working end member is connected to the handle and comprises: (iv) a curved section connected to the handle and disposed at a first acute angle to the longitudinal axis of the handle, and (v) a forked end connected to the curved section comprising a first prong and a second prong disposed to form a curved edge shaped to conform to the curvature of a root surface of a tooth at the gingival level, where die first prong and die second prong are of unequal length, a perimeter of each forked end lies in a plane disposed at a second acute angle to the longitudinal axis of the handle, and both working end members and the handle form a unitary construction.

In one embodiment, the perimeter of each forked end lies in the same plane.

In one embodiment, the perimeter of each forked end lies in different planes such that a bottom face of each forked end is oppositely disposed with respect to the longitudinal axis of the handle.

In one embodiment, a top face and a bottom face of the forked end are flat.

In one embodiment, each of the first acute angle and the second acute angle is in a range of 5-50°.

In one embodiment, the first prong and the second prong each has a width in a range of 0.5-2 mm and a length in a range of 2-3.5 mm.

In one embodiment, an end of each prong is round.

In one embodiment, the curved edge comprises a curve between the first prong and a second prong, wherein the curve has a radius of curvature in a range of 0.5-2 mm, an arc length in a range of 1-3 mm, and a chord length in a range of 0.5-2.5 mm

A second aspect of the disclosure relates to a method for packing a gingival retraction cord around a tooth with the dental tool of the first aspect, the method comprising: (i) laying the gingival retraction cord around the tooth near the marginal gingiva, (ii) positioning the curved edge to fit a curve of a root surface of the tooth, wherein the curve of the root surface is at most a quarter of a perimeter of the root surface, (iii) contacting a bottom face of the forked end with the gingival retraction cord, and (iv) exerting a downward force on the forked end, thereby pressing the gingival retraction cord into a gingival crevice surrounding the tooth.

A third aspect of the disclosure relates to a kit, comprising the dental tool of the first aspect and a gingival retraction cord.

A fourth aspect of the disclosure relates to a dental tool, comprising: (i) a first working end member, (ii) a second working end member, and (iii) a handle therebetween, wherein each working end member is connected to the handle and comprises: (iv) a curved section connected to the handle and disposed at a first acute angle to the longitudinal axis of the handle, and (v) a curved end connected to the curved section comprising a curved edge shaped to conform to the curvature of a root surface of a tooth at the gingival level, where a perimeter of each curved end lies in a same plane disposed at a second acute angle to the longitudinal axis of the handle, and both working end members and the handle form a unitary construction.

In one embodiment, each of the first acute angle and the second acute angle is in a range of 5-50°.

In one embodiment, a top face and a bottom face of the curved end are flat.

In one embodiment, the curved end further comprises a prong with a width in a range of 0.5-2 mm and a length in a range of 2-3.5 mm.

In one embodiment, an end of the prong is round.

A fifth aspect of the disclosure relates to a method for packing a gingival retraction cord around a tooth with the dental tool of the fourth aspect, comprising: (i) laying the gingival retraction cord around the tooth near the marginal gingiva, (ii) positioning the curved end to fit a curve of a root surface of the tooth, wherein the curve of the root surface is at most a quarter of a perimeter of the root surface, (iii) contacting a bottom face of the curved end with the gingival retraction cord, and (iv) exerting a downward force on the curved end, thereby pressing the gingival retraction cord into a gingival crevice surrounding the tooth.

A sixth aspect of the disclosure relates to a kit, comprising the dental tool of the fourth aspect and a gingival retraction cord.

### BRIEF DESCRIPTION OF THE DRAWINGS

FIG, 1 shows an embodiment of the dental tool.

FIG. 2 is an enlarged view showing a working end member of the embodiment of the dental tool shown in FIG. 1.

FIG, 3 shows another embodiment of the dental tool.

FIG. 4 is an enlarged view showing a working end member of the embodiment of the dental tool shown in FIG. 3.

FIG. 5 is a drawing of the forked end.

FIG. 6 shows an embodiment of the curved end which may be useful for packing a gingival retraction cord around incisors.

FIG. 7 shows an embodiment of the forked end which may be useful for packing a gingival retraction cord around canines and premolars.

FIG. 8 shows an embodiment of the forked end which may be useful for packing a gingival retraction cord around molars on the lower jaw.

FIG. 9 shows an embodiment of the forked end which may be useful for packing a gingival retraction cord around molars on the upper jaw.

FIG. 10 is a cross-sectional top view of an embodiment of the forked end and a tooth, showing the curved edge of the forked end fitting to the curvature of the tooth.

FIG. 11 is a front view of a tooth, its adjacent gingival tissue and teeth, where an embodiment of the dental tool is positioned to pack a portion of the gingival retraction cord into the gingival crevice.

FIG. 12 is a front view of the tooth shown in FIG. 11, its adjacent gingival tissue and teeth, where the embodiment of the dental tool shown in FIG. 11 is positioned to pack another portion of the gingival retraction cord into the gingival crevice.

FIG. 13 is a back view of the tooth shown in FIG. 11, its adjacent gingival tissue and teeth, where the embodiment of the dental tool shown in FIG. 11 is positioned to pack another portion of the gingival retraction cord into the gingival crevice.

FIG. 14 is a back view of the tooth shown in FIG. 11, its adjacent gingival tissue and teeth, where the embodiment of the dental tool shown in FIG. 11 is positioned to pack another portion of the gingival retraction cord into the gingival crevice.

FIG. 15 shows an embodiment of the dental tool.

### DETAILED DESCRIPTION OF THE DISCLOSURE

Embodiments of the present disclosure will now be described more fully hereinafter with reference to the accompanying drawings, in which some, but not all embodiments of the disclosure are shown.

The dental tool, also referred to as the gingival retractor instrument, comprises: (i) a first working end member 101, (ii) a second working end member 102, and (iii) a handle 103 therebetween, wherein each working end member is connected to the handle 103 and comprises: (iv) a curved section 104 connected to the handle 103 and disposed at a first acute angle to the longitudinal axis of the handle 103, and (v) a forked end 105 connected to the curved section 104 comprising a firstprong 108 and a second prong 109 disposed to form a curved edge 106 shaped to conform to the curvature of a root surface of a tooth at the gingival level, where a perimeter of each forked end 105 lies in a plane disposed at a second acute angle to the longitudinal axis of the handle 103, and both working end members and the handle 103 form a unitary construction.

The dental tool may be made of stainless steel, cobalt-chromium alloy, titanium, titanium-based alloy, polymer (e.g. nylon, polyester, polytetratluoroethylene), and mixtures thereof. Preferably, the dental tool is made of stainless steel. In one embodiment, the entire dental tool is made of a rigid, non-metallic material, such as the aforementioned polymer, to avoid scratching or otherwise causing damage to dental implant abutments, attachments, fixtures, or other metallic features in an oral cavity. The potential for infection and related damage to gingival tissue, bone, and surrounding teeth may also be minimized. In addition, the use of the non-metallic material also minimizes costs related to production and replacement of the dental tool.

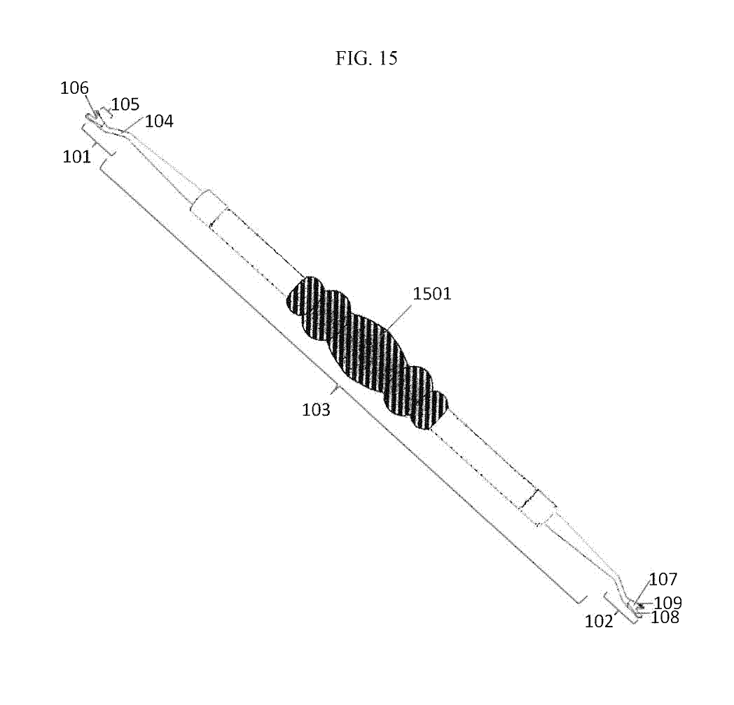

The handle 103 is elongated and sized for manipulation by hand into a patient's mouth. The handle 103 may be of any length (e.g. 50-200 mm, preferably 50-150 mm, more preferably 100-150 mm) and any diameter (e.g. 1-10 mm, preferably 2-7 min, more preferably 4-7 mm). A cross-section of the handle 103 may be a circle or an oval. The term “diameter”, when used for an oval cross-section, refers to the major diameter. The handle 103 may include one or more regions having varying thickness, knurled patterns, or other materials (e.g. a rubber sleeve) to provide a good grip for the dental practitioner. In one embodiment, there is a knurled region in the middle of the handle 103. In another embodiment, there are two knurled regions which are each located between the middle of the handle 103 and each working end member (for example, as shown in FIGS. 1 and 3). The knurled pattern may be an angled pattern, a diamond pattern, or a straight pattern (e.g. axially or circumferentially), preferably a diamond pattern. In some embodiments, the handle 103 has a rubber sleeve. Exemplary types of rubber include, without limitation, natural rubber and synthetic rubber such as neoprene rubber, silicone rubber, EPDM rubber, vinyl rubber, nitrile rubber, butyl rubber, and hypalon rubber. The sleeve may have a shape of a hollow cylinder. In another embodiment, the handle 103 is formed with a series of convex and mutually adjacent knobs 1501 disposed axially therealong and surrounding the middle of the handle 103 (for example, as shown in FIG. 15). Each of the knobs 1501 has a circular cross section that is larger than the diameter of the handle 103. For example, the diameter of the knob is at most 10 mm larger, preferably at most 7 mm larger, more preferably at most 5 mm larger than the diameter of the handle 103. The knobs 1501 may be of the same diameter or increase in diameter from the first knob adjacent each working end member of the dental tool to a medial largest diameter knob. For example, the medial largest diameter knob may have a diameter that is at most 7 mm larger, preferably at most 5 mm larger, more preferably at most 2 mm larger than the diameter of the first knob.

The curved section 104 is disposed at a first acute angle relative to the longitudinal axis of the handle 103. This orientation facilitates the access of the dental tool to the gum line. The first acute angle may be in a range of 5-50°, preferably 15-40°, more preferably 25-35°. Each of the first acute angle of the first and second working end member may be the same or different to enable access to different portions of the tooth. For example, the first acute angle of the first working end member 101 may be smaller than that of the second working end member 102 by at most 15°, preferably at most 10°, more preferably at most 5°. In an embodiment, the curved section 104 has a diameter smaller than that of the handle 103, for facilitating access and maneuverability within the patient's mouth. For example, the diameter of the curved section 104 may be in a range of 0.5-9 mm, preferably 1-5 mm, more preferably 1-3 mm. In one embodiment, the diameter of the curved section 104 is uniform throughout the curved section 104. In another embodiment, the diameter of the curved section 104 tapers from a largest diameter at the connection to the handle 103 to a smallest diameter at the connection to the forked end 105. For example, the largest diameter is at most 8 mm, preferably at most 6 mm, more preferably at most 3 mm larger than the smallest diameter of the curved section 104. A length of the curved section 104 may be in a range of 5-20 mm, preferably 5-15 mm, more preferably 7-12 mm. Each of the curved section 104 of the first and second working end member may have the same length or different lengths to enable access to different portions of the tooth. For example, the curved section 104 of the first working end member 101 may be at most 10 mm longer, preferably at most 5 mm longer, more preferably at most 3 mm longer than the curved section 104 of the second working end member 102.

A perimeter of each forked end 105 lies in a plane disposed at a second acute angle to the longitudinal axis of the handle 103. The second acute angle may be in a range of 5-50°, preferably 15-40°, more preferably 25-35°. Each second acute angle of the first and second working end member may be the same or different to enable access to different portions of the tooth. For example, the second acute angle of the first working end member 101 may smaller than that of the second working end member 102 by at most 15°, preferably at most 10°, more preferably at most 5°. In one embodiment, the perimeter of each forked end 105 lies in the same plane. In another embodiment, the perimeter of each forked end 105 lies in different planes such that the bottom face of each forked end 105 is oppositely disposed relative to the longitudinal axis of the handle. The second acute angle may be the same on each side of the handle but would be in a different direction. For example, one angle could be +30° and the other could be −30° from the longitudinal axis of the handle.

In one embodiment, the first acute angle is larger than the second acute angle by at most 45°, preferably at most 30°, more preferably at most 15°. In another embodiment, the first acute angle is smaller than the second acute angle by at most 45°, preferably at most 30°, more preferably at most 15°.

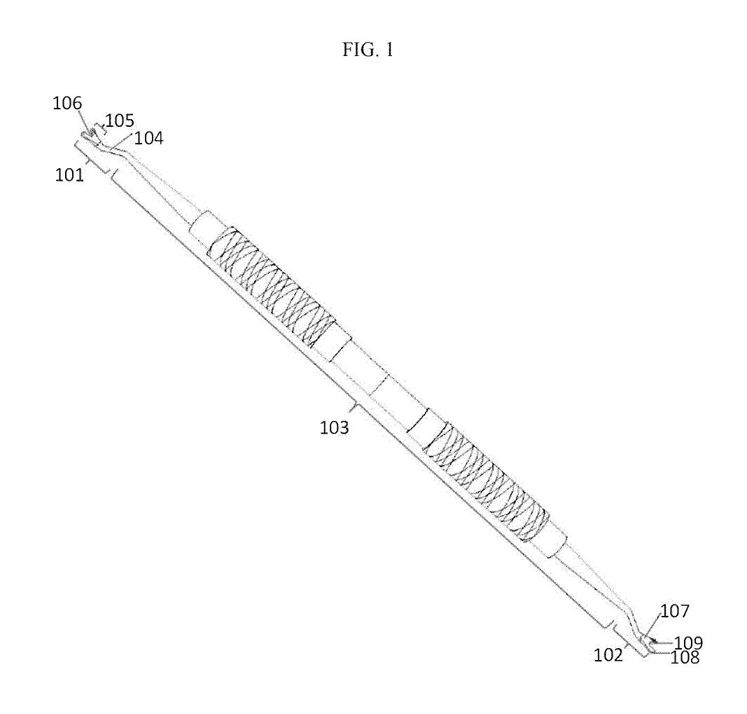

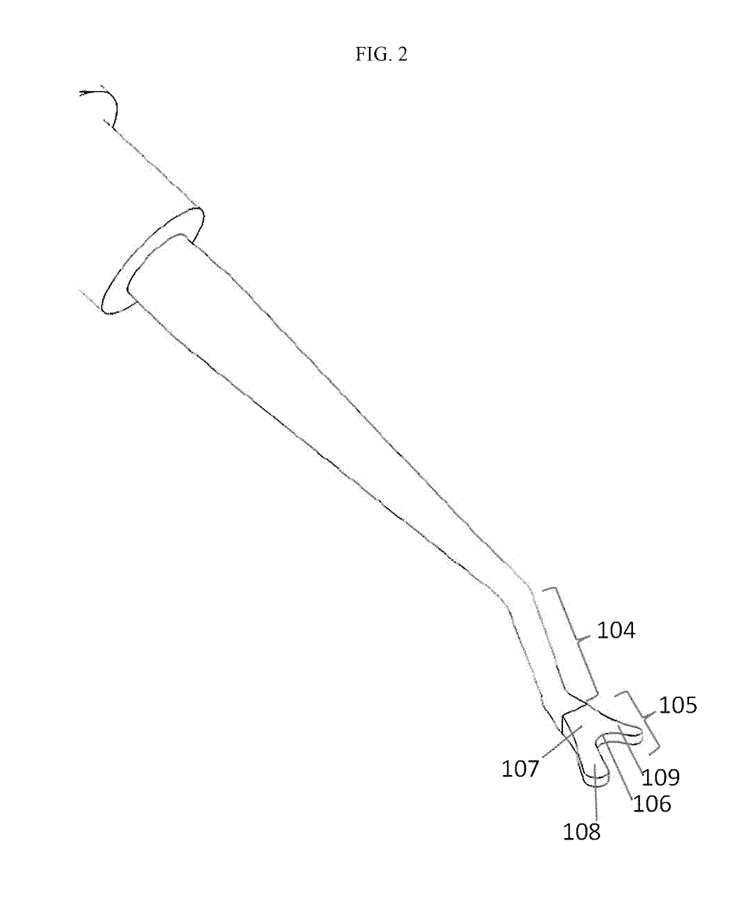

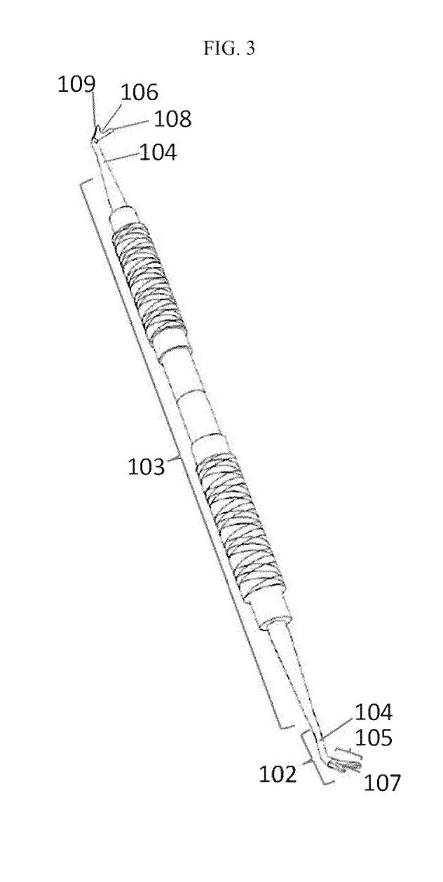

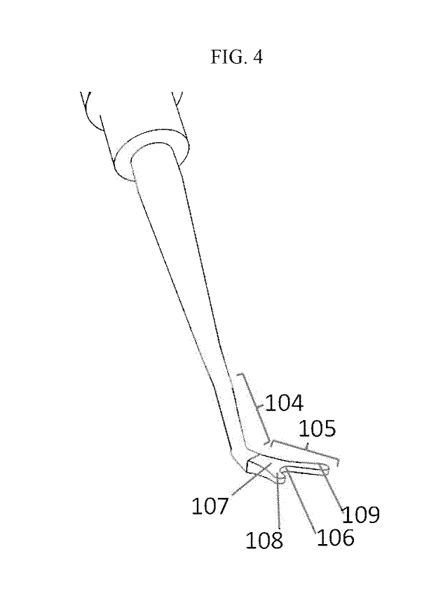

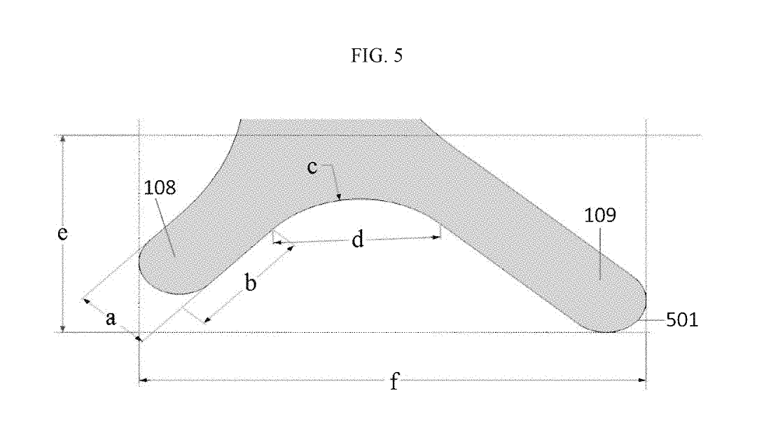

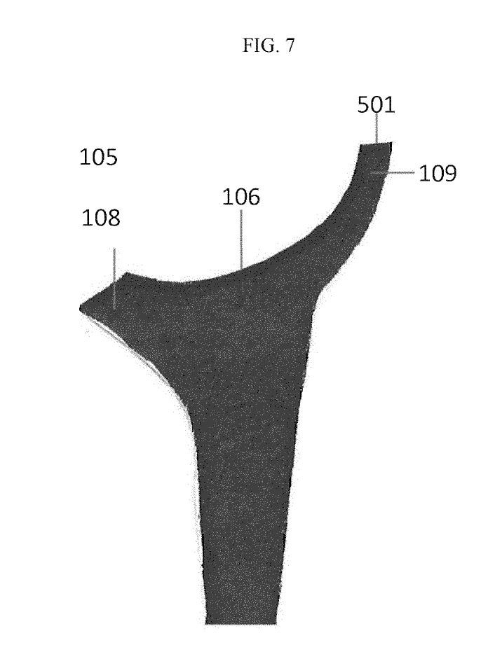

The forked end 105 comprises a first prong 108 and a second prong 109. An end 501 of each prong may be round (for example, as shown in FIGS. 1-5) with a radius of curvature in a range of 0.1-2 mm, preferably 0.1-1 mm, more preferably 0.4-0.6 mm. The term “radius of curvature” refers to the radius of a curve that is a circular arc. The end 501 of each prong may be straight (for example, as shown in FIGS. 7-14). In one embodiment, the end 501 of each prong is not pointed. A top face 107 and a bottom face of the forked end 105 are flat (i.e. not concave or convex). The forked end 105 of the first working end member 101 may be rotationally disposed (for example, in a range of 90-180°, preferably 150-180°, more preferably 175-180°) about a vertical axis passing through the middle of the handle 103 from the forked end 105 of the second working end member 102. This orientation may facilitate access to different regions of an oral cavity and/or different sides of a tooth. In one embodiment, the forked ends 105 of the working end members are mirrorimages of one another.

The forked end 105 may have a variety of dimensions (e.g. length, width, and radius of curvature), depending on the diameter and shape of the tooth 1001 around which a gingival retraction cord 1101 is to be tucked and the position of adjacent teeth.

In one embodiment, the forked end 105 has these dimensions: (i) a length f is in a range of 4-6 mm, preferably 4-5 mm, more preferably 4.4-4.6 mm, (ii) a width e is in a range of 3-4 mm, preferably 3-3.5 mm, more preferably 3.2-3.4 mm, (iii) the curve between the first and second prongs has an arc length c (the distance along the curve) in a range of 1-2 mm, preferably 1.5-2 mm, more preferably 1.7-1.9 mm, (iv) a chord length d (the straight line distance between the endpoints of the curve) is in a range of 1-2 mm, preferably 1.3-1.7 mm, more preferably 1.4-1.6 mm, (v) a radius of curvature of the curve is in a range of 0.5-1.5 mm, preferably 0.5-1 mm, more preferably 0.7-0.9 mm, (vi) a width a of each prong is in a range of 0.5-1.5 mm, preferably 0.7-1.2 mm, more preferably 0.9-1.1 mm, (vii) the first prong 108 has a length b in a range of 1-3 mm, preferably 2-3 mm, more preferably 2,3-2.5 mm, and (viii) the second prong 109 has a length in a range of 0.5-1 mm, preferably 0.7-1 mm, more preferably 0.8-1 mm. This embodiment is designed to conform to the root surface curvature of incisors.

In another embodiment, e forked end 105 has these dimensions: (i) a length f is in a range of 4-6 mm, preferably 5-6 mm, more preferably 5.5-5.7 mm, (ii) a width e is in a range of 2-4 mm, preferably 2.5-3.5 mm, more preferably 2.9-3.1 mm, (iii) the curve between the first and second prongs has an arc length c in a range of 1-2 mm, preferably 1-1.5 mm, more preferably 1-1.2 mm, (iv) a chord length d is in a range of 0.5-2 mm, preferably 0.8-1.5 mm, more preferably 0.9-1.1 mm, (v) a radius of curvature of the curve is in a range of 0.5-1.5 mm, preferably 0.5-1 mm, more preferably 0.6-0.8 mm, (vi) a width a of each prong is in a range of 0.5-1.5 mm, preferably 0.7-1.2 mm, more preferably 0.9-1.1 mm, (vii) the first prong 108 has a length b in a range of 1-3 mm, preferably 2-3 mm, more preferably 2.2-2.4 mm, and (viii) the second prong 109 has a length in a range of 2-3 mm, preferably 2.5-3 mm, more preferably 2.8-3 mm. This embodiment (for example, as shown in FIG. 7) is designed to conform to the root surface curvature of canines and premolars.

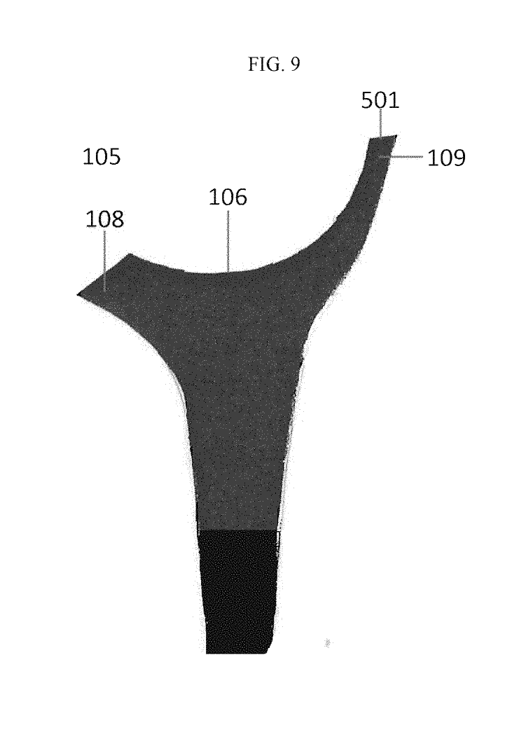

In another embodiment, the forked end 105 has these dimensions: (i) a length f is in a range of 5-7 mm, preferably 5.5-6.5 mm, more preferably 6.2-6.4 mm, (ii) a width e is in a range of 2-4 mm, preferably 2.5-3.5 mm, more preferably 3.0-3.2 mm, (iii) the curve between the first and second prongs has an arc length c in a range of 2-3 mm, preferably 2-2.5 mm, more preferably 2.2-2.4 mm, (iv) a chord length d is in a range of 2-3 mm, preferably 2-2.5 mm, more preferably 2-2.2 mm,(v) a radius of curvature of the curve is in a range of 1-2 mm, preferably 1.3-1.7 mm, more preferably 1.4-1.6 mm, (vi) a width a of each prong is in a range of 0.5-1.5 min, preferably 0.7-1.2 mm, more preferably 0.9-1.1 mm, (vii) the first prong 108 has a length b in a range of 1-3 mm, preferably 1-2 mm, more preferably 1.6-1.8 mm, and (viii) the second prong 109 has a length in a range of 2-3 mm, preferably 2.5-3 mm, more preferably 2.7-2.9 mm. This embodiment (for example, as shown in FIG. 9) is designed to conform to the root surface curvature of molars on the upper jaw.

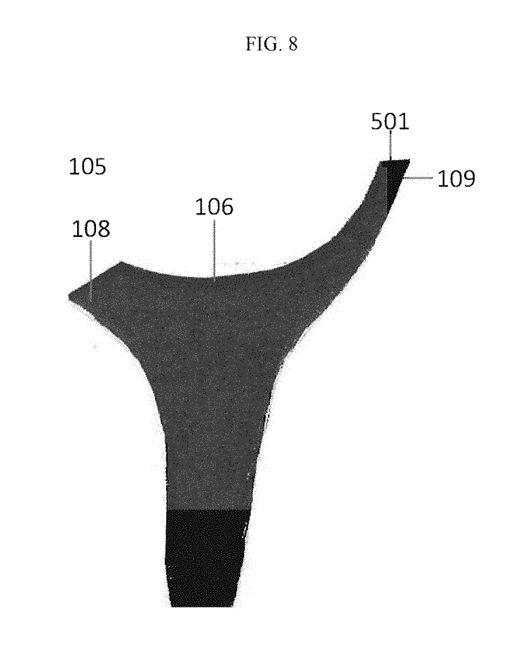

In another embodiment, the forked end 105 has these dimensions: (i) a length f is in a range of 5-7 mm, preferably 5.5-6.5 mm, more preferably 5.8-6 mm, (ii) a width e is in a range of 2-4 mm, preferably 2.5-3.5 mm, more preferably 2.5-2.7 mm, (iii) the curve between the first and second prongs has an arc length c in a range of 1-2 rum, preferably 1.1-1.7 mm, more preferably 1.4-1.6 mm, (iv) a chord length d is in a range of 1-3 mm, preferably 1-2 mm, more preferably 1.3-1.5 mm, (v) a radius of curvature of the curve is in a range of 1-2 mm, preferably 1.3-1.7 mm, more preferably 1.3-1.5 mm, (vi) a width a of each prong is in a range of 0.5-1.5 mm, preferably 0.7-1.2 mm, more preferably 0.9-1.1 mm, (vii) the first prong 108 has a length b in a range of 1-3 mm, preferably 1-2 mm, more preferably 1.7-1.9 mm, and (viii) the second prong 109 has a length in a range of 2-3 mm, preferably 2.5-3 mm, more preferably 2.7-2.9 mm. This embodiment (for example, as shown in FIG. 8) is designed to conform to the root surface curvature of molars on the lower jaw.

Each forked end 105 may have a uniform thickness that is in a range of 0.5-4 mm, preferably 0.5-2 mm, more preferably 0.5-1 mm. In some embodiments, the forked end 105 tapers in thickness from the point where it connects to the curved section 104 to the curve edge of the forked end 105. The thickness at the connection at the curved section 104 may be in a range of 1-4 mm, preferably 1-3 mm, more preferably 1-2 mm. The thickness at the curved edge 106 may be in a range of 0.5-3.5 mm, preferably 0.5-2.5 mm, more preferably 0.5-1 mm.

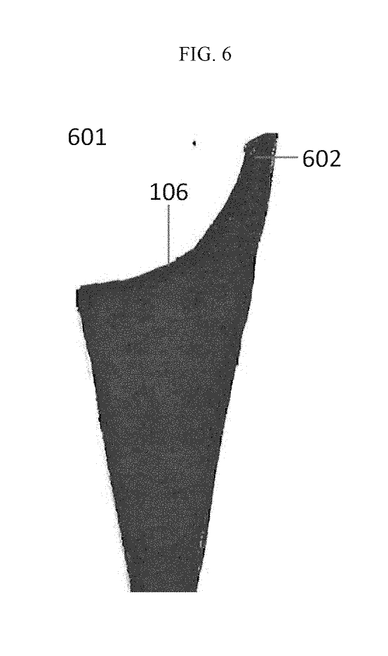

In some embodiments, the dental tool has curved ends 601 in place of forked ends 105 and is designed to conform to the root surface curvature of incisors. The curved end 601 may comprise a prong 602 (for example, as shown in FIG. 6) with a width in a range of 0.5-2 preferably 0.5-1.5 mm, more preferably 0.9-1.1 mm, and a length in a range of 2-3.5 mm, preferably 2-3 mm, more preferably 2.1-2.3 mm. An end of the prong 602 may be round with a radius of curvature in a range of 0.1-2 mm, preferably 0.1-1 mm, more preferably 0.4-0.6 mm. The end of each prong 602 may be straight. In one embodiment, the end the prong 602 is not pointed.

While the dental tools of FIGS. 1 and 3 have been illustrated with opposite forked ends 105 of identical configuration, the forked and curved ends may be mixed to provide curved edges designed to accommodate two different types of teeth. For example, a dental tool may comprise a forked end 105 designed for canines and a curved end 601 designed for incisors. Further, while the curved section 104, forked/curved ends, and the handle 103 have been illustrated and described as unitary, these individual elements may be discrete and fastened together in any suitable manner, such as snap-fitting, force-fitting, adhesives, fasteners, and exterior threads for engagement with complementary interior threads within an end of the handle 103.

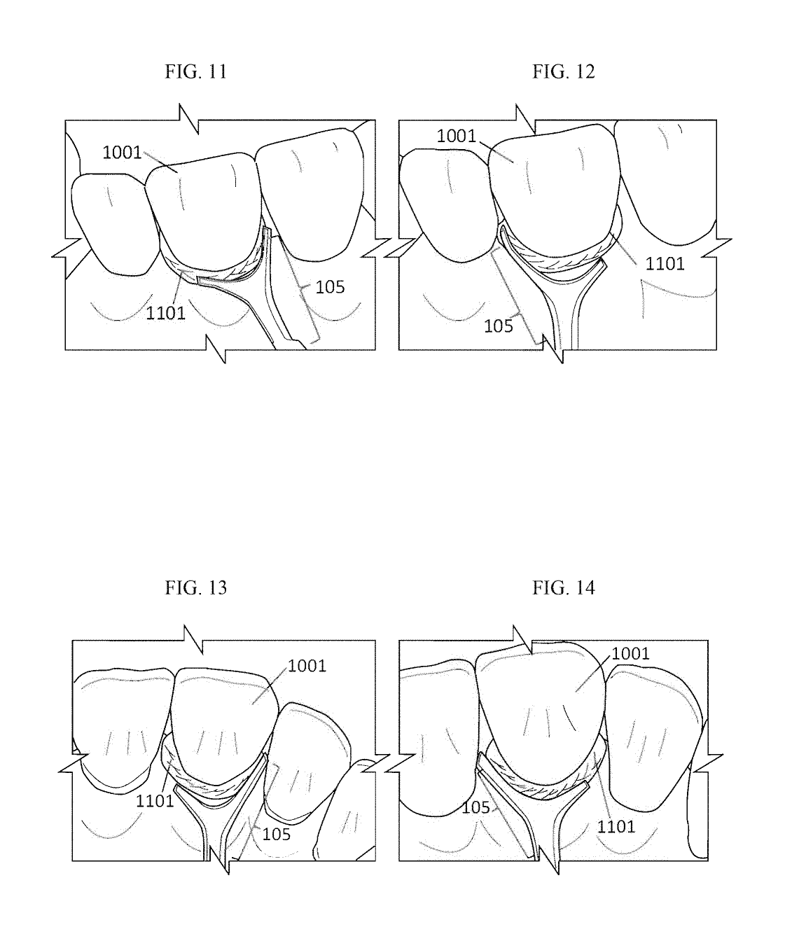

The dental tool may be utilized by dental practitioners to retract gingival tissue, for example, as shown in FIGS. 11 to 14, which illustrates the use of a forked end 105 to retract gingival tissue around a canine. Retracting gingival tissue is commonly preformed in restorative and prosthetic dentistry. In restorative dentistry, for example, when restoration of dental caries at, near, or below the gum line is required, it is necessary to distend and retract the adjacent gingival tissue in order to achieve adequate access to the carious lesion. Such access allows successful removal of caries and placement of fillings (e.g. VLC composite resins or amalgams). In prosthetic dentistry, it is imperative that accurate impressions or molds of a tooth 1001, teeth, or implant be obtained for which prosthetics will subsequently be fabricated at a dental laboratory. At the interface of the tooth surface and gum line, it is important that prior to impression taking that the gingival crevice be retracted so that an accurate impression of the prepared tooth structure can be made. With the disclosed dental tool, the packing of the gingival retraction cord 1101 can be faster and a method of using the dental tool is described hereinafter.

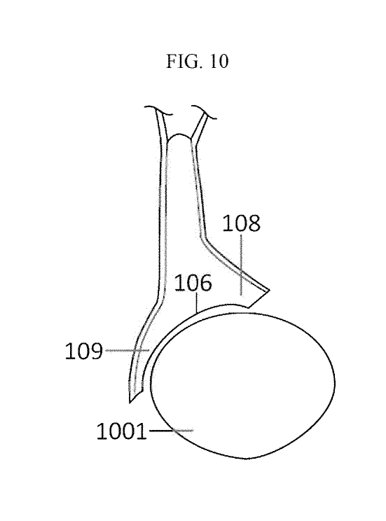

The gingival retraction cord 1101 is first placed around the tooth 1001 near the marginal gingiva. The curved/forked end 105 of either working end member is then positioned to fit a curve of a root surface of the tooth 1001 (for example, as shown in FIGS. 10 and 11), and a prong extends into the interproximal region between the tooth 1001 and the adjacent teeth. The curve of the root surface is at most a quarter of a perimeter of the root surface.

The curved edge 106 is thereby usable to contact a length of the gingival retraction cord 1101, enabling the gingival retraction cord 1101 to be packed into the gingival crevice using a minimum number of strokes due to the length of the forked/curved end.

For example, a first portion of the gingival retraction cord 1101 is packed into the gingival crevice surrounding the front of a tooth 1001 (as shown in FIG. 11) by exerting a downward force on a forked/curved end of the first working end member 101. A slight downward pressure against the gingiva causes the tissue to blanch, which momentarily halts any bleeding or seepage. The dental tool is then rotated so that the forked/curved end of the second working end member 102 is now positioned in a way that fits the curve of the root surface and packs a second portion of the gingival retraction cord 1101 into the gingival crevice surrounding the front of the tooth 1001 (as shown in FIG. 12). The steps are repeated to pack the gingival retraction cord 1101 into the gingival crevice surrounding the back of the tooth 1001 (as shown in FIGS. 13 and 14). To summarize, the gingival retraction cord 1101 may be packed with four simple steps. In comparison, a conventional gingival retraction cord-packing tool contacts a single point along a gingival retraction cord 1101, requiring numerous strokes to pack the entire length of a gingival retraction cord 1101 around a tooth 1001.

By providing a kit with multiple embodiments of the dental tool, a practitioner is able to selectively use a dental tool that is most appropriately configured in size to retract the gum from different tooth structures such as incisors, canines, premolars, and molars. These kits may also comprise a gingival retraction cord 1101.

1. A dental tool, comprising:
a first working end member, a second working end member, and a handle therebetween, wherein each working end member is connected to the handle and comprises:
a curved section connected to the handle and disposed at a first acute angle to a longitudinal axis of the handle; and
a forked end connected to the curved section comprising a first prong and a second prong disposed to form a curved edge shaped to conform to the curvature of a root surface of a tooth at the gingival level, wherein a top face and a bottom face of the forked end are flat
wherein the first prong and the second prong are of unequal length, a perimeter of each forked end lies in a plane disposed at a second acute angle to the longitudinal axis of the handle, and both working end members and the handle form a unitary construction.

2. The dental tool of claim 1, wherein the perimeter of each forked end lies in the same plane.

3. The dental tool of claim 1, wherein the perimeter of each forked end lies in different planes such that the bottom face of each forked end is oppositely disposed with respect to the longitudinal axis of the handle.

4. (canceled)

5. The dental tool of claim 1, wherein each of the first acute angle and the second acute angle is in a range of 5-50°.

6. The dental tool of claim 1, wherein the first prong and the second prong each has a width in a range of 0.5-2 mm and a length in a range of 2-3.5 mm.

7. The dental tool of claim 6, wherein an end of each prong is round.

8. The dental tool of claim 1, wherein the curved edge comprises a curve between the first prong and a second prong, wherein the curve has a radius of curvature in a range of 0.5-2 mm, an arc length in a range of 1-3 mm, and a chord length in a range of 0.5-2.5 mm.

9. A method for packing a gingival retraction cord around a tooth with the dental tool of claim 1, comprising:
laying the gingival retraction cord around the tooth near the marginal gingiva;
positioning the curved edge to fit a curve of a root surface of the tooth, wherein the curve of the root surface is at most a quarter of a perimeter of the root surface;
contacting the bottom face of the forked end with the gingival retraction cord; and
exerting a downward force on the forked end, thereby pressing the gingival retraction cord into a gingival crevice surrounding the tooth.

10. A kit, comprising:
the dental tool of claim 1; and
a gingival retraction cord.

11. A dental tool, comprising:
a first working end member, a second working end member, and a handle therebetween, wherein each working end member is connected to the handle and comprises:
a curved section connected to the handle and disposed at a first acute angle to a longitudinal axis of the handle; and
a curved end connected to the curved section comprising a curved edge shaped to conform to the curvature of a root surface of a tooth at the gingival level, wherein a top face and a bottom face of the curved end are flat;
wherein a perimeter of each curved end lies in a same plane disposed at a second acute angle to the longitudinal axis of the handle, and both working end members and the handle form a unitary construction.

12. The dental tool of claim 11, wherein each of the first acute angle and the second acute angle is in a range of 5-50°.

13. (canceled)

14. The dental tool of claim 11, wherein the curved end further comprises a prong with a width in a range of 0.5-2 mm and a length in a range of 2-3.5 mm.

15. The dental tool of claim 14, wherein an end of the prong is round.

16. A method for packing a gingival retraction cord around a tooth with the dental tool of claim 11, comprising:
laying the gingival retraction cord around the tooth near the marginal gingiva;
positioning the curved end to fit a curve of a root surface of the tooth, wherein the curve of the root surface is at most a quarter of a perimeter of the root surface;
contacting the bottom face of the curved end with the gingival retraction cord; and
exerting a downward force on the curved end, thereby pressing the gingival retraction cord into a gingival crevice surrounding the tooth.

17. A kit, comprising:
the dental tool of claim 11; and
a gingival retraction cord.
